(19) United States
(12) Patent Application Publication
(10) Pub. No.: US 2026/0277251 A1
(43) Pub. Date: Sep. 17, 2026

(54) System and Method for Monitoring an Autonomous Flight of an Aircraft

(71) Applicant: Airbus Operations SAS, TOULOUSE (FR)

(72) Inventors: Monika LITVOVA, TOULOUSE (FR); Jerome GOUILLOU, TOULOUSE (FR)

(21) Appl. No.: 19/043,642

(22) Filed: Feb. 3, 2025

(30) Foreign Application Priority Data
Feb. 5, 2024 (FR) 2401100

(51) Int. Cl. G05D 1/81; B64D 45/04; G05D 1/226; G05D 109/22; G08G 5/26; G08G 5/54; G08G 5/58

(52) U.S. Cl. CPC G05D 1/817; G05D 1/226; G05D 1/49; G05D 1/654; G08G 5/26; G08G 5/54; G08G 5/58; B64D 45/04; G05D 2109/22; G05D 2111/30; G05D 2111/32

(57) ABSTRACT

A system for monitoring an autonomous flight of an aircraft comprises an avionics computer of the aircraft configured to receive or determine autonomous flight information from/of the aircraft, receive, from a radio frequency receiver of the aircraft, a call signal for the aircraft originating from a ground station, with the call signal being independent of any transmission of information from the ground station to the aircraft, and send, after receiving a call signal during an autonomous flight of the aircraft, a go-around command to a flight management system of the aircraft so as to initiate a go-around maneuver.

### CROSS-REFERENCES TO RELATED APPLICATIONS

This application claims the benefit of French Patent Application Number 2401100 filed on Feb. 5, 2024, the entire disclosure of which is incorporated herein by way of reference.

### FIELD OF THE INVENTION

The invention relates to the field of autonomous flight for aircraft.

### BACKGROUND OF THE INVENTION

Some aircraft include a system designed to allow autonomous flight of the aircraft under certain circumstances, with this autonomous flight notably being designed to perform an automatic landing of the aircraft on a runway of a diversion airport. In one embodiment, the considered circumstances correspond to the aircraft crew being unable to fly. As is known, an aircraft can be equipped with an on-board system for detecting an inability to fly affecting the aircraft crew. When such an inability to fly by the aircraft crew is detected, information is transmitted to the aforementioned system that is designed to allow autonomous flight of the aircraft. A mode for piloting the aircraft in autonomous mode is then initiated and corresponding information is sent to a ground station, in particular to an Air Traffic Control (ATC) center. Since the crew is unable to fly, communications between the aircraft and the ATC center only occur from the aircraft to the ATC center (automatic messages sent at a set frequency). As such a flight in autonomous mode corresponds to an emergency situation, a controller in the air traffic control center carefully monitors the autonomous flight of the aircraft. They notably monitor the flight forecast information that is automatically transmitted by the aircraft: planned trajectory, planned runway for landing, etc. In particular, the controller manages the traffic of surrounding aircraft so as to free up the airspace needed to allow the aircraft to fly according to the planned trajectory transmitted to the air traffic control center. The controller also takes measures to ensure that the runway is available for the aircraft to land. However, despite the measures taken by the air traffic controller, an unforeseen event affecting the ability of the aircraft to land on the runway cannot be completely ruled out: intrusion of a vehicle on the runway, poor weather conditions, etc. Therefore, it would be advisable for the controller to be able to send a request to the aircraft to prevent it from landing on the runway in case of an unforeseen event.

### SUMMARY OF THE INVENTION

Notably, an aim of the present invention is to provide a solution to this problem. It relates to a system for monitoring an autonomous flight of an aircraft, comprising an avionics computer of the aircraft configured to:
receive or determine autonomous flight information from/of the aircraft;
receive, from a radio frequency receiver of the aircraft, a call signal for the aircraft originating from a ground station, with the call signal being independent of any transmission of information from the ground station to the aircraft; and
send, after receiving a call signal during an autonomous flight of the aircraft, a go-around command to a flight management system of the aircraft so as to initiate a go-around maneuver.

Thus, when ground station personnel (for example, an air traffic controller) detect an event affecting the possibility of the aircraft landing on the runway, they can send a call signal to the aircraft. After the call signal is received on board the aircraft, this results in a command for the aircraft to perform a go-around. This prevents the aircraft from immediately landing on the runway.

According to one embodiment, the aircraft call signal is a SelCal type call signal.

According to another embodiment, the call signal corresponds to a telephone call type ringtone from the ground station to the aircraft.

In a particular embodiment, the autonomous flight information of the aircraft corresponds to a situation whereby the crew of the aircraft is unable to fly.

Advantageously, the avionics computer is also configured to:
receive altitude information from the aircraft; and
only send the go-around command to the aircraft flight management system if the altitude of the aircraft is below a predetermined altitude threshold.

In particular, the avionics computer is also configured to send the ground station information corresponding to a flight forecast for the aircraft, if the altitude of the aircraft is greater than the predetermined altitude threshold.

The invention also relates to a method for monitoring an autonomous flight of an aircraft, the method comprising the following steps implemented by an avionics computer of the aircraft:
A) receiving or determining autonomous flight information from/of the aircraft;
B) receiving, from a radio frequency receiver of the aircraft, a call signal for the aircraft originating from a ground station, with the call signal being independent of any transmission of information from the ground station to the aircraft; and
C) sending, after receiving a call signal during an autonomous flight of the aircraft, a go-around command to a flight management system of the aircraft so as to initiate a go-around maneuver.

In one embodiment, step C) comprises the following sub-steps:
C1) receiving altitude information from the aircraft; and
C2a) only sending the go-around command to the aircraft flight management system if the altitude of the aircraft is below a predetermined altitude threshold.

In particular, step C) further comprises a sub-step C2b) involving sending the ground station information corresponding to a flight forecast for the aircraft, if the altitude of the aircraft is greater than the predetermined altitude threshold.

Advantageously, the method further comprises the following steps implemented before step B):
α1) the ground station receiving a landing forecast for the aircraft in autonomous flight on a specified runway of an airport;
α2) in case of an event that is likely to compromise landing on the runway, the ground station transmitting a call signal for the aircraft.

The invention also relates to an aircraft comprising such a system for monitoring an autonomous flight of the aircraft.

### BRIEF DESCRIPTION OF THE PREFERRED EMBODIMENTS

The invention will be better understood upon reading the following description and with reference to the appended figures.

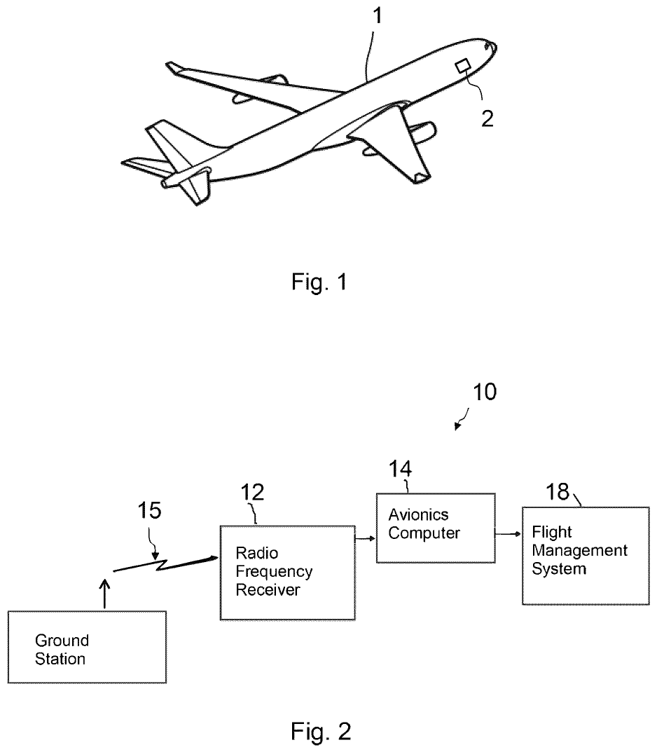

FIG. 1 illustrates an aircraft equipped with a system for monitoring an autonomous flight of the aircraft.

FIG. 2 schematically illustrates a system for monitoring an autonomous flight of the aircraft according to one embodiment of the invention.

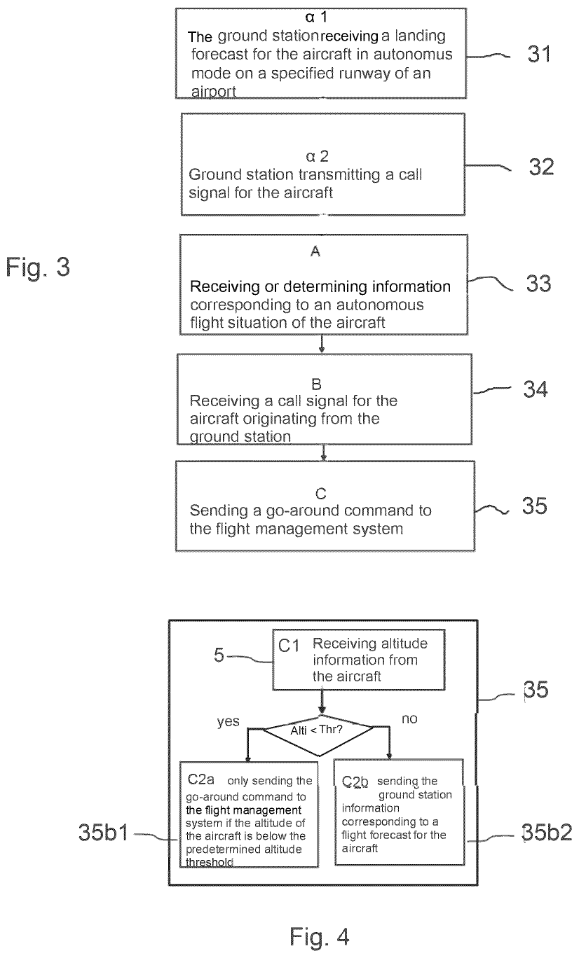

FIG. 3 illustrates a method for monitoring an autonomous flight of the aircraft according to one embodiment of the invention.

FIG. 4 illustrates a particular embodiment of the method for monitoring an autonomous flight of the aircraft of FIG. 3.

### DETAILED DESCRIPTION OF THE PREFERRED EMBODIMENTS

The system 10 for monitoring an autonomous flight shown in FIG. 2 comprises an avionics computer 14 of an aircraft, such as the aircraft 1 illustrated in FIG. 1. The output of the avionics computer 14 is connected to a Flight Management System (FMS) 18 of the aircraft. Also, the input of the avionics computer 14 is connected to a radio frequency receiver 12 of the aircraft, for example, a VHF (Very High Frequency) type receiver designed to communicate with a ground station 16 via a radio frequency link 15. Alternatively, the radio frequency receiver 12 corresponds to a SATCOM-type satellite communications receiver designed to communicate with the ground station 16 via a satellite radio frequency link. The ground station 16 corresponds, for example, to an air traffic control center. The monitoring system 10 is installed, for example, in an avionics bay 2 of the aircraft.

During operation, when the aircraft 1 transitions to autonomous flight mode, for example, during an emergency situation, such as the aircraft crew being unable to fly, the aircraft determines a possible runway for landing at a diversion airport, as well as a diversion trajectory toward this runway. The aircraft sends a message to the ground station 16 via the radio communication link 15 or via another communication link. This message is intended to inform a ground station operator that the aircraft is in autonomous flight and it also contains information corresponding to the diversion trajectory and to the specified runway at the diversion airport.

The ground station operator then monitors the availability of the specified runway. If they detect an event that is likely to compromise the possibility of the aircraft landing on the specified runway, in particular the intrusion of a vehicle on the runway or a poor weather situation, the operator sends a call signal to the aircraft via the radio communication link 15. This call signal is a signal independent of any transmission of information from the ground station to the aircraft, i.e., the operator sends this call signal to the aircraft without including any information corresponding to the meaning of the call signal (namely, the unavailability of the runway). The call signal is therefore a signal of the type informing the aircraft that the ground station wishes to contact the aircraft. According to one embodiment, the call signal is a SelCal (Selective Calling) type call signal. The SelCal type call signal is a selective call signal that only targets the considered aircraft as a function of a SelCal registration number assigned to this aircraft. According to another embodiment, the call signal corresponds to a telephone call type ringtone initiated by the ground station and intended for the aircraft. This telephone call is made, for example, via a SATCOM-type satellite link.

The call signal is received by the radio frequency receiver 12 of the aircraft, which transmits it to the avionics computer 14. The avionics computer checks whether the aircraft is in autonomous flight. To this end, it checks whether it has previously determined autonomous flight information for the aircraft or whether it has received such information from another aircraft system such as, for example, a system for monitoring the inability of the aircraft crew to fly. If the call signal has been received during an autonomous flight of the aircraft, the avionics computer 14 sends a go-around command to the flight management system 18 of the aircraft. This allows a go-around maneuver by the aircraft to be commanded and thus prevents the aircraft from landing on a runway that is not available. Using a call signal to this end without communicating other information from the ground station to the aircraft improves the responsiveness of the system, on the one hand, and limits the occupancy of the communication frequencies, on the other hand. This also has the advantage of not requiring complex interpretation of instructions that could otherwise be sent in natural language by the ground station operator.

In a particular embodiment, the avionics computer 14 also receives altitude information Alti from the aircraft and it only sends the go-around command to the flight management system 18 if the altitude of the aircraft is below a predetermined altitude threshold Thr. In particular, this altitude threshold Thr corresponds to a height relative to the runway threshold of the specified runway or relative to the overflown terrain. For example, the altitude of the runway threshold of the specified runway is acquired by the avionics computer 14 from a database on board the aircraft. In particular, the aforementioned height corresponds to a height below which the aircraft is in the final approach phase for the considered runway. This height is selected, for example, so as to be substantially equal to 3,000 feet (approximately 914 meters).

Advantageously, if the altitude of the aircraft is above the predetermined altitude threshold when the avionics computer 14 receives the call signal, the avionics computer sends the ground station information corresponding to a flight forecast for the aircraft. This thus allows the ground station 16 operator to ask the aircraft to send the information. It is thus possible to reduce the frequency for automatically transmitting information to the ground station from the aircraft in an autonomous flight situation. This allows the occupancy of the communication frequencies to be reduced. The aircraft flight forecast information notably corresponds to information relating to the runway specified for landing the aircraft and/or to information relating to the diversion trajectory that has been specified for joining this runway.

The corresponding method is illustrated in FIG. 3. It comprises the following steps implemented by the avionics computer 14:
a step 33 (labeled A in the figure) of receiving or determining information corresponding to an autonomous flight situation of the aircraft;
a step 34 (labeled B in the figure) of receiving, from the radio frequency receiver 12, a call signal for the aircraft 1 originating from the ground station 16, with the call signal being independent of any transmission of information from the ground station to the aircraft; and
a step 35 (labeled C in the figure), after receiving a call signal during an autonomous flight of the aircraft, of sending a go-around command to the flight management system 18 of the aircraft, so as to initiate a go-around maneuver of the aircraft.

In a particular embodiment illustrated in FIG. 4, step 35 comprises:
a sub-step 35a (labeled C1 in the figure) for receiving altitude information Alti from the aircraft; and
a sub-step 35b1 (labeled C2a in the figure) involving only sending the go-around command to the flight management system 18 of the aircraft if the altitude of the aircraft is below the predetermined altitude threshold Thr.

In particular, the method further comprises a sub-step 35b2 (labeled C2b in the figure) involving sending the ground station 16 information corresponding to a flight forecast for the aircraft, if the altitude of the aircraft is greater than the predetermined altitude threshold Thr.

Advantageously, the method further comprises the following steps implemented before step 34:
a step 31 (labeled α1 in the figure) involving the ground station 16 receiving a landing forecast for the aircraft in autonomous flight on a specified runway of an airport; and
in case of an event that is likely to compromise landing on the runway, a step 32 (labeled α2 in the figure) involving the ground station 16 transmitting a call signal for the aircraft.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. A system for monitoring an autonomous flight of an aircraft, comprising an avionics computer of the aircraft configured to:
receive or determine autonomous flight information from or of the aircraft;
receive, from a radio frequency receiver of the aircraft, a call signal for the aircraft originating from a ground station, with the call signal being independent of any transmission of information from the ground station to the aircraft; and
send, in response to receiving the call signal during an autonomous flight of the aircraft, a go-around command to a flight management system of the aircraft so as to initiate a go-around maneuver.

2. The system as claimed in claim 1, wherein the call signal of the aircraft is a SelCal type call signal.

3. The system as claimed in claim 1, wherein the call signal corresponds to a telephone call type ringtone from the ground station to the aircraft.

4. The system as claimed in claim 1, wherein the autonomous flight information of the aircraft corresponds to a situation whereby an aircraft crew is unable to fly the aircraft.

5. The system as claimed in claim 1, wherein the avionics computer is also configured to:
receive altitude information from the aircraft; and
only send the go-around command to the aircraft flight management system if the altitude of the aircraft is below a predetermined altitude threshold.

6. The system as claimed in claim 5, wherein the avionics computer is also configured to send the ground station information corresponding to a flight forecast for the aircraft, if the altitude of the aircraft is greater than the predetermined altitude threshold.

7. A method for monitoring an autonomous flight of an aircraft, the method comprising the following steps implemented by an avionics computer of the aircraft:
A) receiving or determining autonomous flight information from or of the aircraft;
B) receiving, from a radio frequency receiver of the aircraft, a call signal for the aircraft originating from a ground station, with the call signal being independent of any transmission of information from the ground station to the aircraft; and
C) sending, in response to receiving the call signal during an autonomous flight of the aircraft, a go-around command to a flight management system of the aircraft so as to initiate a go-around maneuver.

8. The method as claimed in claim 7, wherein step C) comprises the following sub-steps:
C1) receiving altitude information from the aircraft; and
C2a) only sending the go-around command to the aircraft flight management system if the altitude of the aircraft is below a predetermined altitude threshold.

9. The method as claimed in claim 8, wherein step C) further comprises a sub-step C2b) involving sending the ground station information corresponding to a flight forecast for the aircraft, if the altitude of the aircraft is greater than the predetermined altitude threshold.

10. The method as claimed in claim 7, further comprising the following steps implemented before step B):
α1) the ground station receiving a landing forecast for the aircraft in autonomous flight on a specified runway of an airport; and
α2) in case of an event that is likely to compromise landing on the runway, the ground station transmitting the call signal for the aircraft.

11. An aircraft comprising a system for monitoring an autonomous flight of the aircraft as claimed in claim 1.
